(19) United States
(12) Patent Application Publication
(10) Pub. No.: US 2025/0207474 A1
(43) Pub. Date: Jun. 26, 2025

(54) DRILLING AND CEMENTING UNIVERSAL FLUIDS AND METHODS AND SYSTEMS RELATED THERETO

(71) Applicant: SAUDI ARABIAN OIL COMPANY, Dhahran (SA)

(72) Inventors: Guoqing JIAN, Houston, TX (US); Ashok SANTRA, Houston, TX (US); Arthur HALE, Houston, TX (US); Qusai A. DARUGAR, Houston, TX (US)

(73) Assignee: SAUDI ARABIAN OIL COMPANY, Dhahran (SA)

(21) Appl. No.: 18/393,406

(22) Filed: Dec. 21, 2023

(51) Int. Cl. E21B 33/138; C09K 8/467; E21B 10/60

(52) U.S. Cl. CPC E21B 33/138; C09K 8/467; E21B 10/60

(57) ABSTRACT

Methods comprising pre-mixing a flowable universal fluid (UF) composition that is settable from a fluid state to a solid state, wherein the fluid UF composition comprises: an aqueous-based carrier fluid; a cement precursor; and, a delaying agent. And drilling a wellbore in a subterranean formation using the fluid UF composition, wherein a portion of the fluid UF composition remains in the wellbore upon completing the drilling; and introducing an activator and heating the portion of fluid UF composition in the wellbore under formation temperature conditions, thereby solidifying the fluid UF composition into a solid UF composition in the wellbore.

### FIELD OF THE DISCLOSURE

The present disclosure relates generally to wellbore drilling and/or cementing operations in the oil and gas industry; more particularly, the present disclosure relates to drilling and cementing universal fluids, and methods and systems related thereto.

### BACKGROUND OF THE DISCLOSURE

The production of crude oil and other hydrocarbons begins with the drilling of a wellbore through a subterranean formation and into a hydrocarbon reservoir. Drilling of a wellbore generally involves circulating a drilling fluid (or drilling mud) from a surface location of the wellbore to a downhole location through a drill string. The drilling fluid exits through ports (or jets) in a drill bit, which bores through the formation and forms the wellbore. The drilling fluid aids in cooling and lubricating the drill bit and further picks up cuttings and carries the cuttings up an annulus formed between an inner wall of the wellbore and an outer wall of the drill string. The drilling fluid and the cuttings flow through the annulus to the surface, where the cuttings are separated from the fluid. For various environmental, sustainability, and practical reasons, aqueous-based drilling fluids may be preferred for wellbore drilling operations.

The wellbore may be isolated from the surrounding subterranean formation using a cementing operation. During a cementing operation, a cement sheath is placed within a wellbore between the subterranean formation and a casing (or liner string). The cement sheath is formed by pumping a cement slurry through the bottom of the casing and out through the annulus between the outer casing wall and the formation face of the wellbore. The cement slurry then cures in the annular space, thereby forming a sheath of hardened cement that, among other functions, supports and positions the casing in the wellbore and bonds the exterior surface of the casing to the subterranean formation.

The transition between a drilling operation and a cementing operation may result in various issues that require additional remedial steps, such as for example, operator costs associated with time, economic expenditures, and equipment wear and tear. For example, after performing a drilling operation, residual aqueous-based drilling fluid may remain within the drilled wellbore, presenting significant challenges related to, for example, zonal isolation due to unstable and/or poor cement bonding, mud-channeling, or other fluid migration-related interferences.

Indeed, fluid loss (or lost circulation) is a common form of such residual drilling fluid, in which the drilling fluid is imbibed or otherwise seeps into the pore matrix of a subterranean formation. Fluid loss can occur in various subterranean formations, such as naturally fractured formations, cavernous formations, and highly permeable formations (e.g., formations having a permeability greater than 500 millidarcy), regardless of the wellbore geometry (e.g., horizontal, vertical, deviated, or otherwise tortuous).

Traditionally, to address the challenges encountered when transitioning between a drilling operation and a cementing operation, after drilling and prior to cementing, a clean-up spacer fluid is utilized to cleanse the drilling fluid from the wellbore. However, such spacer fluid does not always fully displace the drilling fluid and may be ineffective at displacing drilling fluids, including associated formed filter cake, in near wellbore fractures or high permeability layers. Moreover, such spacer fluids themselves tend to be aqueous-based and may not fully be recovered from the wellbore to the surface, thus failing to remedy the above challenges.

In view of the aforementioned, the present disclosure provides an ecologically and economically friendly universal fluid for use in both drilling and cementing operations related to a wellbore for use in the oil and gas industry.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method is provided including: pre-mixing a flowable universal fluid (UF) composition that is settable from a fluid state to a solid state upon activation, wherein the fluid UF composition comprises: an aqueous-based carrier fluid; a cement precursor; and a delaying agent; drilling a wellbore in a subterranean formation using the fluid UF composition, wherein a portion of the residual fluid UF composition remains in the wellbore upon completing the drilling; and introducing an activator and heating the portion residual of fluid UF composition in the wellbore under formation temperature conditions, thereby solidifying the fluid UF composition into a solid UF composition in the wellbore.

In another embodiment consistent with the present disclosure, a system is provided including: a drill string extendable into a wellbore from a drilling platform and conveying a pre-mixed flowable universal fluid (UF) composition, the fluid UF composition comprising: an aqueous-based carrier fluid; a cement precursor; a delaying agent; and wherein the fluid UF composition solidifies under formation temperature conditions, thereby forming a solid UF composition; and introducing an activator.

In a further embodiment consistent with the present disclosure, a universal fluid is provided including: a pre-mixed flowable universal fluid (UF) composition, wherein the fluid UF composition comprises: an aqueous-based carrier fluid; a cement precursor; a delaying agent; an activator; and wherein the fluid UF composition solidifies under formation temperature conditions, thereby forming a solid UF composition.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWING

FIG. 1 is cross-sectional side view of an example well system that may incorporate one or more principles of the present disclosure.

FIG. 2A is a schematic drawing of a subterranean formation showing fluid loss zones.

FIG. 2B is a schematic drawing of the subterranean formation of FIG. 2A with introduction of the UF compositions of the present disclosure.

FIG. 3 is a chart showing compositional components of various cement precursors for use in the UF compositions of the present disclosure.

FIG. 4 is a chart showing solidification time periods for various UF compositions of the present disclosure.

FIGS. 5A-5C are various views of a solidified UF composition of the present disclosure.

FIG. 6 is a chart showing thickening time of a UF composition of the present disclosure.

FIGS. 7A and 7B are charts showing fluid loss control in terms of volume and filter cake size, respectively, using the UF compositions of the present disclosure.

### DETAILED DESCRIPTION

Embodiments in accordance with the present disclosure generally relate to wellbore drilling and/or cementing operations in the oil and gas industry; more particularly, the present disclosure relates to drilling and cementing universal fluids, and methods and systems related thereto.

The present disclosure provides a universal fluid (“UF”) composition, and related methods and systems, for use as a dual drilling fluid and cementing fluid. More specifically, the UF composition transforms from a fluid state, suitable for use as a drilling fluid, to a solid state, suitable to act as a high-strength cement over time. The UF compositions described herein do not require the use of any activator to make the transition from liquid to solid. Rather than requiring an activator, the UF compositions of the present disclosure are self-activated over time at formation temperature conditions. In practice, however, an activator is generally used in the methods and compositions of the present disclosure to control the timing of the transition from fluid to solid.

Advantageously, the UF compositions described herein allow for the transformation of any residual UF composition remaining in a wellbore into a portion of a cement sheath, alleviating the various challenges discussed above. Moreover, beneficially, the UF compositions of the present disclosure can completely eliminate the need for remedial clean-up spacer fluids traditionally placed between drilling fluid and cementing fluids. Another advantage of the UF compositions described herein is increased bonding strength of the cured cement sheath between the subterranean formation and casing due to the similarity of composition of the UF composition in the inactivated and activated states compared to traditional drilling and cement fluid bonding strength.

Further, the UF compositions of the present disclosure utilize environmentally friendly, sustainable materials to reduce the carbon footprint without compromising or improving field-ready rheology, high-strength cement, controllable mud-to-cement transition, and fluid loss control.

### Definitions

As used herein, the term “wellbore,” and grammatical variants thereof refers to a drilled hole or borehole, including an open hole or uncased portion of the wellbore, within a subterranean formation. A wellbore may be of any geometry, including vertical, horizontal, deviated, or otherwise tortuous.

As used herein, the term “subterranean formation,” and grammatical variants thereof refers to a rock beneath a surface of the Earth, whether a land surface or subsea surface, for which crude oil or hydrocarbons can be recovered. The rock may comprise, for example, shale, sandstone-based rock, carbonate-based rock, and the like.

As used herein, the term “fluid UF composition,” and grammatical variants thereof, with reference to the UF compositions of the present disclosure refers to the UF compositions that are pumpable and suitable for use as a drilling fluid. The fluid UF compositions are characterized as a flowable liquid-phase state of matter that may comprise various solid and/or gaseous states of matter dispersed throughout, which flow with the flowable liquid-phase. The fluid UF compositions are used for drilling operations in a wellbore in a subterranean formation.

As used herein, the term “solid UF composition,” and grammatical variants thereof, with reference to the UF compositions of the present disclosure refers to the UF compositions in a solid state. The solid UF compositions are characterized as non-flowable solid-phase state of matter. The solid UF compositions are used for cementing operations in a wellbore in a subterranean formation.

The term “UF composition,” and grammatical variants thereof, refers interchangeably to both the fluid UF compositions and the solid UF compositions of the present disclosure, unless explicitly stated otherwise.

As used herein, the terms “inactivated” or “inactivated state,” and grammatical variants thereof, refer to the fluid UF compositions of the present disclosure (which have yet to be activated).

As used herein, the terms “activated” and “activated state,” and grammatical variants thereof, refer to the solid UF compositions of the present disclosure (which have been activated in the absence of the presence of an activator under formation temperature conditions).

As used herein, the term “cement precursor,” and grammatical variants thereof, refers to a solid material (component of the fluid UF composition) that when mixed with water and subjected to appropriate formation temperature conditions can be cured to form a cement (solid UF composition).

As used herein, the term “viscosifier,” and grammatical variants thereof, refers to a substance that can increase the viscosity of the fluid UF compositions of the present disclosure. Viscosifiers thus represent a class of rheology modifiers and may be alternatively referred to in the industry as “thickeners” or “thickening agents.”

As used herein, the term “delaying agent,” and grammatical variants thereof, refers to a substance that can reduce the time until curing time of the fluid UF compositions of the present disclosure to form the solid UF compositions described herein.

As used herein, the term “fluid loss control agent,” and grammatical variants thereof, refers to a substance that lowers the volume of filtrate that passes through a filter medium. In particular, the fluid loss control agent controls the loss of fluid to a subterranean formation through filtration, including during drilling and/or cementing operations.

As used herein, the terms “plastic viscosity” or “PV,” and grammatical variants thereof, refer to a rheology property related to the resistance of an aqueous-based fluid (i.e., the fluid UF compositions of the present disclosure) to flow due to mechanical interaction between solids therein. The PV is expressed in centipoise (cP) and may be calculated by measuring the shear stress of the aqueous-based fluid using a rheometer at spindle speeds of 300 rotations per minute (rpm) and 600 rpm and subtracting the 300 rpm dial reading from the 600 rpm dial reading according to the Equation (I): PV=(Dial Reading at 600 rpm)−(Dial Reading at 300 rpm).

As used herein, the terms “yield point” or “YP,” and grammatical variants thereof, refer to a rheology property related to the value obtained from the Bingham-Plastic rheological model when extrapolated to a shear rate of zero. The YP is expressed as force per area, such as foot-pounds per 100 square feet (lbf/100 ft²) and may be calculated using 300 rpm and 600 rpm shear rate readings and the PV value (expressed in Equation (I)) according to the Equation (II): YP=(Dial Reading at 300 rpm)−PV.

As used herein, the terms “low shear yield point” or “LSYP,” and grammatical variants thereof, refer to a rheology property related to an estimate of the yield stress at the lowest shear stress value above which a material will behave like a fluid and below which the material will behave like a solid. LSYP is expressed as force per area, such as lbf/100 ft², and may be calculated by measuring the shear stress of the aqueous-based fluid using a rheometer at spindle speeds of 3 rotations per minute (rpm) and 6 rpm according to Equation (III): LSYP=[2*(Dial Reading at 3 rpm)]−(Dial Reading at 6 rpm)].

Unless otherwise indicated, the rheology properties (PV, YP, LSYP) of the fluid UF compositions of the present disclosure is measured according to API RP 13B-1 (2023) at 120° F. (48.9° C.) after heat rolling at 160° F. (71.1° C.) for 16 hours.

As used herein, the term “fluid loss zone,” and grammatical variants thereof, refers to a target zone of interest in a wellbore in which fluid loss occurs. A fluid loss zone may encompass an area encountered during various subterranean formation operations (e.g., drilling operations, cementing operations) where the volume a treatment fluid is imbibed by a subterranean formation through a wellbore wall. A rate of loss of 1 to 10 barrels per hour (bbl/h) is characterized as seepage-loss that may occur in any formation; a rate of loss of 10 to less than 500 bbl/h is characterized as moderate-loss that may occur in porous formations or those having relatively small natural or induced fractures; and a rate of loss of equal to or greater than 500 bbl/h is characterized as severe-loss that may occur in highly permeable formations or those having relatively large natural or induced fractures. Severe-loss may include total fluid loss; severe-loss can result in complete abandonment of a well.

Unless otherwise indicated, fluid loss is determined at 160° F. and a differential pressure of 500 psi according to API RP 13B-1 (2023).

As used herein, the term “formation temperature conditions,” and grammatical variants thereof, refers to a downhole temperature which activates the solidification of the fluid UF compositions into the solid UF compositions of the present disclosure.

As used herein, the term “life time,” and grammatical variants thereof, refers to the time in which a fluid UF composition of the present disclosure becomes a solid UF composition or cannot be used as drilling fluid anymore having desired mechanical properties (e.g., compressive strength) without activation. The life time of such drilling fluid is the time UF can be used as drilling fluid in the absence of an external activator. The UF has a long enough life time to stay in liquid form, which makes it suitable as a drilling fluid and allows it to complete the drilling operation before the activation starts.

As used herein, the term “thickening time,” and grammatical variants thereof, refers to the time from the point at which the fluid UF composition and reaches 70 Bearden units (Bc) at target temperature, e.g. 160° F. (71.1° C.), until the material is fully set, at or above 90 Bc. Unless otherwise indicated, the thickening time of an activated fluid UF composition of the present disclosure is measured according to API RP 10B-2 (2013).

As used herein, the term “compressive strength,” and grammatical variants thereof, refers to a mechanical property of the solid UF compositions of the present disclosure related to the capacity of a solid UF composition specimen to withstand axially directed pushing forces. Unless otherwise indicated, the compressive strength of the solid UF compositions of the present disclosure is measured according to API RP 10B-2 (2019).

### UF Compositions

The UF compositions of the present disclosure are formulated such that desired rheological properties are achieved during drilling operations and desired mechanical properties are achieved during cementing operations within a wellbore in a subterranean formation. Generally, the primary components of the UF compositions are pre-mixed prior to use in a drilling and/or cementing operation.

During drilling operations, the UF composition is in the form of a fluid UF; during cementing operations, the UF composition is in the form of a solid UF composition.

It is to be appreciated that while the present disclosure discussed the use of the UF compositions of the present disclosure during subterranean formation wellbore drilling and cementing operations, other subterranean formation operations may additionally employ the UF compositions described herein, without departing from the scope of the present disclosure. Such operations may include, but are not limited to, completion operations, stimulation operations (e.g., fracturing operations), enhanced oil recovery operations (e.g., conformance control), and the like, and any combination thereof.

In general, the UF compositions of the present disclosure comprise primary components of at least an aqueous-based carrier fluid, a cement precursor, and a delaying agent. In some embodiments, the UF compositions may further include one or more viscosifiers and/or one or more fluid loss control agents. Additional additives also may be included in the UF compositions of the present disclosure, such as those listed herein below. However, as described herein, the UF compositions of the present disclosure do not require an activator to convert a fluid UF composition (for drilling a wellbore) into a solid UF composition (for forming a cement sheath), though the addition of an activator is often useful to control the timing of the transition from fluid to solid.

The aqueous-based carrier fluid may include, but is not limited to, freshwater, acidified water, salt water, seawater, brine (e.g., a saturated salt solution), or an aqueous salt solution (e.g., a non-saturated salt solution), purified wastewater, deionized water, and any combination thereof. In one or more instances, the aqueous carrier fluid is “slick water,” having a low viscosity of generally less than about 100 cP, such as in the range of about 1 cP to about 50 cP, encompassing any value and subset therebetween, such as in the range of about 1 cP to about 10 cP, or about 10 cP to about 20 cP, or about 20 cP to about 30 cP, or about 30 cP to about 40 cP, or about 40 cP to about 50 cP, or about 10 cP to about 30 cP, or about 15 cP to about 35 cP.

The aqueous-based carrier fluid of the present disclosure may be used to dissolve or otherwise suspend components of the UF compositions described herein into a wellbore during a drilling and/or cementing operation.

The cement precursors of the present disclosure are the primary components of the UF compositions and impart, at least, desired curing profile time, rheology properties (e.g., viscosity, yield strength), and mechanical properties (e.g., compressive strength).

The cement precursor material may be hydraulic or non-hydraulic. A hydraulic cement precursor material refers to a mixture of limestone, clay, and gypsum burned together under temperatures greater than 1000° C. that may begin to cure (harden) relatively quickly within the UF compositions (i.e., while in contact with water). A non-hydraulic cement precursor material refers to a mixture of lime, gypsum, plasters, and oxychloride that generally takes comparatively longer to cure (harden) and/or may require certain drying conditions, such as heat and time. The selection of a hydraulic cement precursor or non-hydraulic cement precursor may thus depend on the parameters of the particular wellbore to be drilled, such as depth, length, and trajectory to ensure that the time prior to the curing of a fluid UF composition is sufficient to complete desired drilling operations.

Examples of suitable cement precursors may include, but are not limited, to Portland cement, fly ash (e.g., siliceous fly ash, calcareous fly ash), slag (e.g., blast furnace slag), pozzolan, volcanic ash (e.g., trass, tuff), silica fume, quartz, and the like, and any combination thereof. The cement precursors, may include, but are not limited to, silicon dioxide (SiO₂), calcium oxide (CaO), calcium hydroxide, iron oxide (Fe₂O₃), aluminum oxide (Al₂O₃), titanium dioxide (TiO₂), magnesium oxide (MgO), strontium oxide (SrO), potassium oxide (K₂O), sulfur trioxide (SO₃), barium oxide (BaO), manganese oxide (MnO), manganese tetroxide (Mn₃O₄), belite (Ca₂SiO₅), alite (Ca₃SiO₄), tricalcium aluminate (Ca₃Al₂O₆), tetracalcium aluminoferrite (Ca₄Al₂Fe₂O₁₀), brownmilleriate (4CaO·Al₂O₃·Fe₂O₃), gypsum (CaSO₄.2H₂O), limestone, hexavalent chromium, trivalent chromium, calcium aluminate, silica sand, silica flour, hematite, and the like, and any combination thereof.

When the selected cement precursor is a silica species, an alumina species, or a combination thereof, the solid UF composition for cement operations may be in the form of a geopolymer upon contact with alkaline conditions, resulting in a high-strength cement solid.

One or more cement precursors may be included in the UF compositions of the present disclosure in an amount in the range of about 30% by weight (wt %) to about 75 wt %, encompassing any value and subset therebetween, such as about 30 wt % to about 35 wt %, or about 35 wt % to about 40 wt %, or about 40 wt % to about 45 wt %, or about 45 wt % to about 50 wt %, or about 50 wt % to about 55 wt %, or about 55 wt % to about 60 wt %, or about 60 wt % to about 70 wt %, or about 70 wt % to about 75 wt %, or about 55 wt % to about 75 wt %, or about 60 wt % to about 75 wt %, or about 50 wt % to about 65 wt %, or about 65 wt % to about 75 wt %.

One or more viscosifiers may be included in the UF compositions to influence the viscosity of the fluid UF compositions as it is circulated within a subterranean formation during a drilling and/or cementing operation. The viscosity may affect, for example, the pumpability of the fluid UF compositions, including pump rate and equipment requirements. The viscosity of the fluid UF compositions represents its resistance to flow, defined as the ratio of shear stress to shear rate.

Viscosifiers for use in the UF compositions of the present disclosure may include, but are not limited to, natural and derivatized polysaccharides, polyacrylamide and its derivatives, bentonite that are soluble, dispersible or swellable in the UF compositions (i.e., aqueous-based carrier fluid) to impart or increase viscosity. Suitable examples of polysaccharide viscosifiers may include, but are not limited to, natural and derivatized gums, natural and derivatized celluloses, and the like, and any combination thereof. Specific examples of suitable viscosifiers for use in forming the UF compositions of the present disclosure may include, but are not limited to, guar gum, hydroxyalkyl gum (e.g., hydroxypropyl guar gum), carboxyalkyl guar gum (e.g., carboxymethyl guar gum, carboxymethylpropyl guar gum), xanthan gum, hydroxyalkyl xanthan gum (e.g., hydroxypropyl xanthan gum), carboxyalkyl xanthan gum (e.g., carboxymethyl xanthan gum), carboxyalkyl hydroxyalkyl xanthan gum (e.g., carboxymethyl hydroxypropyl xanthan gum), cellulose, hydroxyalkyl cellulose (e.g., hydroxytheyl cellulose, hydroxypropyl cellulose, Methyl 2-hydroxyethyl cellulose), carboxyalkyl cellulose (e.g., carboxymethyl cellulose), carboxyalkyl hydroxyalkyl cellulose (e.g., carboxymethyl hydroxyethyl cellulose) and the like, and any combination thereof.

One or more viscosifiers may be included in the UF compositions of the present disclosure in an amount in the range of about 0.05 wt % to about 1 wt %, encompassing any value and subset therebetween, such as about 0.05 wt % to about 0.1 wt %, or about 0.1 wt % to about 0.2 wt %, or about 0.2 wt % to about 0.3 wt %, or about 0.3 wt % to about 0.4 wt %, or about 0.4 wt % to about 0.5 wt %, or about 0.5 wt % to about 0.6 wt %, or about 0.6 wt % to about 0.7 wt %, or about 0.7 wt % to about 0.8 wt %, or about 0.8 wt % to about 0.9 wt %, or about 0.9 wt % to about 1 wt %, or about 0.5 wt % to about 1 wt %, or about 0.05 wt % to about 0.1 wt %, or about 0.1 wt % to about 0.5 wt %.

The curing time of the fluid UF composition to form the solid UF composition described herein for use as part of a cementing operation to form a cement sheath may be influenced or otherwise delayed with one or more delaying agents provided in the UF composition. Suitable delaying agents may include, but are not limited to, lignosulfonate, sodium borate, zinc borate, boric acid, sodium tartrate, sodium citrate, sodium gluconate, sodium itaconate, tartaric acid, citric acid, gluconic acid, itaconic acid, and the like, and any combination thereof.

One or more delaying agents may be included in the UF compositions of the present disclosure in an amount in the range of about 0.05 wt % to about 4 wt %, encompassing any value and subset therebetween, such as about 0.05 wt % to about 0.1 wt %, or about 0.1 wt % to about 0.25 wt %, or about 0.25 wt % to about 0.5 wt %, or about 0.5 wt % to about 0.75 wt %, or about 0.75 wt % to about 1 wt %, or about 1 wt % to about 1.25 wt %, or about 1.25 wt % to about 1.5 wt %, or about 1.5 wt % to about 1.75 wt %, or about 1.75 wt % to about 2 wt %, or about 2 wt % to about 2.25 wt %, or about 2.25 wt % to about 2.5 wt %, or about 2.5 wt % to about 2.75 wt %, or about 2.75 wt % to about 3 wt %, or about 0.5 wt % to about 1 wt %, or about 1 wt % to about 3 wt %, or about 2 wt % to about 3 wt %, or about 2 wt % to about 4 wt %, or about 3 wt % to about 4 wt %.

A fluid loss control agent may be included in the UF compositions described herein the prevent or reduce fluid loss during drilling and/or cementing operations. The fluid loss control agent, in some embodiments, may further act as a viscosifier, depending on the selected fluid loss control agent. Examples of suitable fluid loss control agents for use in the UF compositions of the present disclosure may include, but are not limited to, starch, hydroxyalkyl starch (e.g., hydroxyethyl starch, hydroxypropyl starch), carboxyalkyl starch (e.g., carboxymethyl starch), hydroxyethylcellulose, hydrophobically modified hydroxyethylcellulose, carboxymethylhydroxyethylcellulose, guar, modified guar, polyvinyl alcohol, polyethyleneimine, bentonite clay, montmorillonite clay, anhydrous sodium silicate, grafted polymers prepared by the polymerization of monomers or salts of monomers of N,N-dimethylacrylamide, 2-acrylamido-2-methylpropanesulfonic acid and acrylonitrile having a lignin or lignite or other backbone, copolymers or salts of copolymers of N,N-dimethylacrylamide and 2-acrylamido-2-methylpropanesulfonic acid, and the like, and any combination thereof.

One or more fluid loss control agents may be included in the UF compositions of the present disclosure in an amount in the range of about 0.05 wt % to about 4 wt %, encompassing any value and subset therebetween, such as about 0.05 wt % to about 0.1 wt %, or about 0.1 wt % to about 0.25 wt %, or about 0.25 wt % to about 0.5 wt %, or about 0.5 wt % to about 0.75 wt %, or about 0.75 wt % to about 1 wt %, or about 1 wt % to about 1.25 wt %, or about 1.25 wt % to about 1.5 wt %, or about 1.5 wt % to about 1.75 wt %, or about 1.75 wt % to about 2 wt %, or about 2 wt % to about 2.25 wt %, or about 2.25 wt % to about 2.5 wt %, or about 2.5 wt % to about 2.75 wt %, or about 2.75 wt % to about 3 wt %, or about 0.5 wt % to about 1 wt %, or about 1 wt % to about 3 wt %, or about 2 wt % to about 3 wt %, or about 2 wt % to about 4 wt %, or about 3 wt % to about 4 wt %.

As stated above, the UF compositions of the present disclosure do not require an activator to solidify. However, an activator may be included in the UF compositions to control the timing and to speed up the fluid to solid transition, without departing from the scope of the present disclosure. Examples of suitable optional activators may include, but are not limited to, sodium hydroxide, sodium silicate, potassium silicate, potassium hydroxide, sodium carbonate, sodium sulfate, lime, slaked lime and the like, and any combination thereof. When incorporated, one or more activators may be included in the UF compositions of the present disclosure in an amount in the range of about 1 wt % to about 8 wt %, encompassing any value and subset therebetween, such as about 1 wt % to about 2 wt %, or about 2 wt % to about 3 wt %, or about 3 wt % to about 4 wt %, or about 4 wt % to about 5 wt %, or about 1 wt % to about 3 wt %, or about 1 wt % to about 4 wt %, or about 3 wt % to about 5 wt %, or about 2 wt % to about 5 wt %.

When included, the activator may decrease the solidification time period of the UF compositions under formation temperature conditions, such as in the range of about 1 hours to about 28 hours, encompassing any value and subset there between, such as about 1 hours to about 5 hours, or about 5 hours to about 10 hours, or about 10 hours to about 15 hours, or about 15 hours to about 20 hours, or about 20 hours to about 28 hours, or about 2 hours to about 10 hours, or about 10 hours to about 28 hours.

The rheological properties of the fluid UF compositions described herein may be determined by measuring the shear stress on the fluid UF compositions at different shear rates. The various shear rates are utilized because aqueous-based fluid UF compositions can behave as a rigid body at lesser shear stresses but flow as a viscous fluid at greater shear stresses. The rheology of the fluid UF compositions may be characterized by its PV, YP, and LSYP, as defined above.

The PV is related to the resistance of the fluid UF compositions to flow due to mechanical interaction between solids, such as fines, entrained within the fluid UF compositions during drilling operations. The PV represents the viscosity of the fluid UF compositions extrapolated to infinite shear rate. PV may be increased by viscous base fluids and excess colloidal solids.

In some embodiments, the fluid UF compositions of the present disclosure may have a PV at 120° F. in the range of about 25 cP to about 100 cP, encompassing any value and subset therebetween, such as about 25 cP to about 50 cP, or about 50 cP to about 75 cP, or about 75 cP to about 100 cP, or about 50 cP to about 100 cP, or about 25 cP to about 75 cP, or about 40 cP to about 80 cP, or about 35 cP to about 75 cP. In some instances, the fluid UF composition has a PV at 120° F. in the range of about 8 cP to about 35 cP.

The fluid UF compositions of the present disclosure may behave as a rigid body when the shear stress is less than the YP and may flow as a fluid when the shear stress is greater than the YP. That is, the yield point represents the amount of stress required to move the drilling fluid from a static condition. Yield point provides an indication of the ability of the fluid UF compositions to carry solids, such as rock cuttings, during drilling operations, through the annulus, which, in simplified terms, gives an indication of the ability of a fluid UF composition to lift cuttings away from the bottom of a wellbore in a subterranean formation. As an example, a drilling or completion fluid for primary well control having a YP of equal to or greater than 15 lbf/100 ft² is considered acceptable for drilling a wellbore.

In one or more aspects of the present disclosure, the fluid UF compositions of the present disclosure may have a YP at 120° F. in the range of about 10 lbf/100 ft² to about 75 lbf/100 ft², encompassing any value and subset therebetween, such as about 10 lbf/100 ft² to about 25 lbf/100 ft², or about 25 lbf/100 ft² to about 35 lbf/100 ft², or about 35 lbf/100 ft² to about 45 lbf/100 ft², or about 45 lbf/100 ft² to about 55 lbf/100 ft², or about 55 lbf/100 ft² to about 65 lbf/100 ft², or about 65 lbf/100 ft² to about 75 lbf/100 ft², or about 20 lbf/100 ft² to about 75 lbf/100 ft², or about 25 lbf/100 ft² to about 75 lbf/100 ft², or about 25 lbf/100 ft² to about 70 lbf/100 ft². In some embodiments, the fluid UF compositions of the present disclosure may have a YP at 120° F. in the range of about 15 lbf/100 ft² to about 25 lbf/100 ft².

The LSYP of the fluid UF compositions of the present disclosure plays a significant role in wellbore cleaning and the carrying capacity of the fluid UF compositions. Generally, improved rheology is obtained with lower LSYP values. In one or more aspects of the present disclosure, the LSYP of the fluid UF compositions at 120° F. may be in the range of about 4 lbf/100 ft² to about 16 lbf/100 ft², encompassing any value and subset therebetween, such as about 4 lbf/100 ft² to about 6 lbf/100 ft², or about 6 lbf/100 ft² to about 8 lbf/100 ft², or about 8 lbf/100 ft² to about 10 lbf/100 ft², or about 10 lbf/100 ft² to about 12 lbf/100 ft², or about 12 lbf/100 ft² to about 14 lbf/100 ft², or about 14 lbf/100 ft² to about 16 lbf/100 ft², or about 5 lbf/100 ft² to about 15 lbf/100 ft², or about 5 lbf/100 ft² to about 10 lbf/100 ft², or about 4 lbf/100 ft² to about 10 lbf/100 ft². In some embodiments, the fluid UF compositions of the present disclosure may have a LSYP at 120° F. in the range of about 7 lbf/100 ft² to about 15 lbf/100 ft².

As described above, the fluid UF compositions may become solid UF compositions (i.e., for cementing purposes). Moreover, the solid UF compositions of the present disclosure can effectively address fluid loss zones ranging from minor fluid loss (seepage-loss) to complete fluid loss (severe-loss).

Solidification of the fluid UF compositions may occur under formation temperature conditions. In one or more aspects, these formation temperature conditions may be, without limitation, in the range of about 120° F. to about 200° F. (or about 48.9° C. to about 93.3° C.), encompassing any value and subset therebetween, such as about 120° F. to about 130° F., or about 130° F., to about 140° F., or about 140° F. to about 150° F., or about 150° F. to about 160° F., or about 160° F. to about 170° F., or about 170° F. to about 180° F., or about 180° F. to about 190° F., or about 190° F. to about 200° F.

The solidification time period for forming the solid UF compositions from the fluid UF compositions (without activator) under formation temperature conditions (about 120° F. to about 200° F.) may be in the range of about 0 days to about 70 days, encompassing any value and subset therebetween, such as about 0 days to about 5 days, or about 5 days to about 10 days, or about 10 days to about 15 days, or about 15 days to about 20 days, or about 20 days to about 25 days, or about 25 days to about 30 days, or about 30 days to about 35 days, or about 35 days to about 40 days, or about 40 days to about 45 days, or about 45 days to about 50 days, or about 50 days to about 55 days, or about 55 days to about 60 days, or about 60 days to about 65 days, or about 65 days to about 70 days, or about 23 days to about 50 days, or greater than about 23 days. The solidification time period is accordingly sufficiently long to enable performance of drilling operations, where the UF compositions remain in a flowable state until drilling of a wellbore is complete. The particular solidification time period may depend on a number of factors and can be tuned accordingly, such as based on the formation temperature conditions, the concentration of delaying agent, the like, and any combination thereof.

The compressive strength of the solid UF compositions of the present disclosure is a function of both cement maturity (solidification time) and the formation temperature conditions. Typically, a greater formation temperature will reduce solidification time. In one or more aspects, the compressive strength of the solid UF compositions may be in the range of about 100 psi to about 15,000 psi, encompassing any value and subset therebetween, such as about 100 psi to about 1,500 psi, or about 1,500 psi to about 3,000 psi, or about 3,000 psi to about 4,500 psi, or about 4,500 psi to about 6,000, psi, or about 6,000 psi to about 7,500 psi, or about 7,500 psi to about 9,000 psi, or about 9,000 psi to about 10,500 psi, or about 10,500 psi to about 12,000 psi, or about 12,000 psi to about 13,500 psi, or about 13,500 psi to about 15,000 psi, or about 250 psi to about 12,000 psi, or about 500 psi to about 10,000 psi.

Accordingly, the UF compositions of the present disclosure are flowable and become solidified over a solidification time period under suitable formation temperature conditions, as described herein. That is, the present disclosure provides convertible UF compositions that convert from a flowable wellbore drilling fluid into a rigid, solid cementitious material for use in forming a cement sheath in the drilled wellbore under formation temperature conditions. The UF compositions of the present disclosure can effectively address fluid loss zones ranging from minor fluid loss (seepage-loss) to complete fluid loss (severe-loss).

### Methods and Systems for Drilling and Cementing Using UF Compositions

In one or more embodiments, the components of the UF compositions may be mixed to form the fluid UF compositions and the fluid UF compositions may be introduced into a subterranean formation to form a wellbore. A portion of the fluid UF compositions may contact and be lost to the subterranean formation in one or more fluid loss zones. Upon exposure to formation temperature conditions, the fluid UF compositions within these fluid loss zones solidifies into the solid UF compositions described herein for use in cementing operations and, additionally, fluid loss control.

Accordingly, embodiments in accordance with the present disclosure include the use of a UF composition during drilling and cementing operations. As described above, other subterranean formation operations requiring lost circulation control are also applicable to the embodiments of the present disclosure.

Embodiments and examples of the present disclosure will be described in detail with reference to accompanying Figures. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

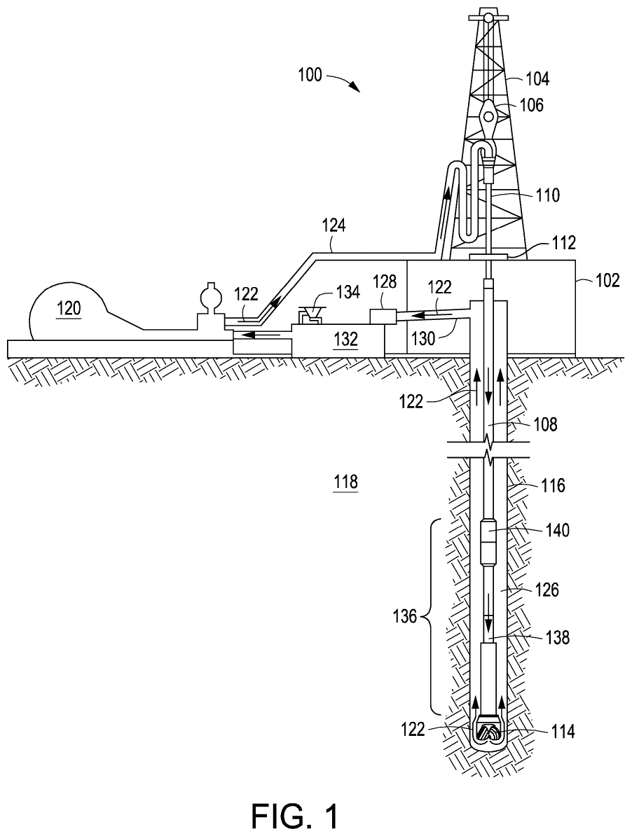

Referring to FIG. 1, illustrated is an exemplary drilling system 100 that may employ the principles of the present disclosure. It should be noted that while FIG. 1 generally depicts a land-based drilling assembly, those skilled in the art will readily recognize that the principles described herein are equally applicable to subsea drilling operations that employ floating or sea-based platforms and rigs, without departing from the scope of the disclosure. As illustrated, the drilling system 100 may include a drilling platform 102 that supports a derrick 104 having a traveling block 106 for raising and lowering a drill string 108. The drill string 108 may include, but is not limited to, drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a wellbore 116 that penetrates various subterranean formations 118.

A pump 120 (e.g., a mud pump) circulates a fluid UF composition (drilling fluid) 122 through a feed pipe 124 and to the kelly 110, which conveys the fluid UF composition 122 downhole through the interior of the drill string 108 and through one or more orifices in the drill bit 114. The fluid UF composition 122 is then circulated back to the surface via an annulus 126 defined between the drill string 108 and the walls of the wellbore 116. It is to be appreciated that all or a portion of wellbore 116 may be vertical (as shown), horizontal, or deviated, without departing from the scope of the present disclosure.

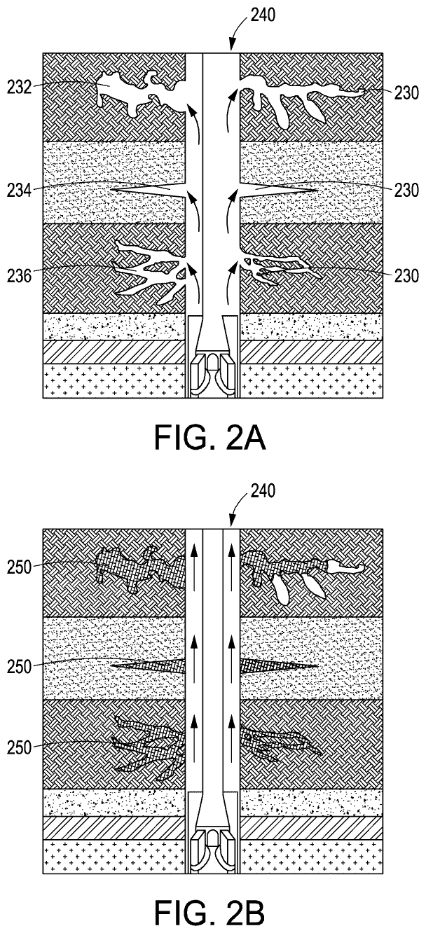

At the surface, the recirculated or spent fluid UF composition fluid 122 exits the annulus 126 and may be conveyed to one or more fluid processing unit(s) 128 via an interconnecting flow line 130. After passing through the fluid processing unit(s) 128, a “cleaned” fluid UF composition 122 may be deposited into a nearby retention pit 132 (i.e., a mud pit). One or more chemicals, fluids, or additives may be added to the fluid UF composition 122 via a mixing hopper 134 communicably coupled to or otherwise in fluid communication with the retention pit 132. As described herein, a portion of the fluid UF composition 122 may not return to the surface and otherwise remain within the wellbore 116 and imbibed into the subterranean formation 118 through various fluid loss zones, for example (see FIGS. 2A and 2B).

The drilling system 100 may further include a bottom hole assembly (BHA) 136 arranged in the drill string 108 at or near the drill bit 114. The BHA 136 may include any of a number of sensor modules 138 (one shown) which may include formation evaluation sensors and directional sensors, such as measuring-while-drilling and/or logging-while-drilling tools. These sensors are well known in the art and are not described further. The BHA 136 may also contain a pulser system 140 which induces pressure fluctuations in the flow of the fluid UF composition 122. Data from the downhole sensor modules 138 are encoded and transmitted to the surface via the pulser system 140 whose pressure fluctuations, or “pulses,” propagate to the surface through the column of fluid UF composition 122 in the drill string 108. At the surface the pulses are detected by one or more surface sensors (not shown), such as a pressure transducer, a flow transducer, or a combination of a pressure transducer and a flow transducer.

If one or more fluid loss zones are encountered during a drilling operation (e.g., loss of fluid UF composition 122 to the subterranean formation 118 through the wellbore 116), the fluid UF composition 122 of the present disclosure may imbibed herein and remain in the wellbore 116 rather than being recirculated to the surface.

With reference to FIGS. 2A and 2B, a wellbore (e.g., a hydrocarbon wellbore) is illustrated during a drilling operation, which may comprise any of the components and systems described with reference to FIG. 1. To recover hydrocarbons within the subterranean formation, a wellbore 240 is drilled within the subterranean formation to establish fluid contact with hydrocarbon bearing zones of the subterranean formation (see FIG. 1). However, during drilling of the wellbore 240, various fluid loss zones 230 may be encountered. Such fluid loss zones 230 may include, but are not limited to, fractures, voids, vugulars, gaps, permeable channels, cavities, cavernous openings, the like, and any combination thereof. As shown in FIG. 2A, fluid loss zones 230 of FIG. 2A (and FIG. 2B) include cavernous openings 232, induced fractures 234, and natural fractures 236. Cavernous opening 232 may be a large hollow void in the subterranean formation that would readily allow fluid UF composition 122 (see FIG. 1) to enter and be diverted from returning to the surface through the annulus (see FIG. 1). Induced fractures 234 are areas of cracking or increased permeability in the subterranean formation resulting from aspects of the drilling operation. For example, elevated pressure in the wellbore 240 from pumping of the fluid UF composition 122 may result in separation of layers and opening of channels according to the natural stresses within the formation. Similarly, natural fractures 236 include separation of layers and channels throughout the formation resulting from natural geological movement and stress relief within the formation. It is to be appreciated that each of cavernous openings 232, induced fractures 234, and natural fractures 236 (among other permeability openings) present challenges to drilling operations as the fluid UF composition 122 may be diverted into these fluid loss zones 230 instead of being returned to the surface via the annulus.

The fluid loss zones 230 of the subterranean formation may be sequestered from the wellbore 240 by solidification of remaining fluid UF composition 122 within the wellbore as part of a drilling operation. The solidification results in a solid UF composition 250 under formation temperature conditions that does not interfere with subsequent cementing operations and, in face, forms a portion of a cement sheath while simultaneously providing fluid loss control. FIG. 2A provides an illustration of the subterranean formation upon drilling a wellbore with a fluid UF composition 122 and prior to solidification thereof in accordance with methods of the present disclosure. FIG. 2B provides an illustration of the fluid loss zones 230 obstructed with a solid UF composition 250 under formation temperature conditions.

Embodiments disclosed herein include:

Embodiment A: A method comprising: pre-mixing a flowable universal fluid (UF) composition that is settable from a fluid state to a solid state upon activation, wherein the fluid UF composition comprises: an aqueous-based carrier fluid; a cement precursor; and, a delaying agent; drilling a wellbore in a subterranean formation using the fluid UF composition, wherein a portion of the residual fluid UF composition remains in the wellbore upon completing the drilling; and introducing an activator and heating the portion of the residual fluid UF composition in the wellbore under formation temperature conditions, thereby solidifying the fluid UF composition into a solid UF composition in the wellbore.

Embodiment B: A system comprising: a drill string extendable into a wellbore from a drilling platform and conveying a pre-mixed flowable universal fluid (UF) composition, the fluid UF composition comprising: an aqueous-based carrier fluid; a cement precursor; a delaying agent; and wherein the fluid UF composition solidifies under formation temperature conditions, thereby forming a solid UF composition; and introducing an activator.

Embodiment C: A composition comprising: a pre-mixed flowable universal fluid (UF) composition, wherein the fluid UF composition comprises: an aqueous-based carrier fluid; a cement precursor; a delaying agent; an activator; and wherein the fluid UF composition solidifies under formation temperature conditions, thereby forming a solid UF composition.

Each of embodiments A, B, and C may have one or more of the following additional elements in any combination:

Element 1: wherein the aqueous-based carrier fluid is selected from the group consisting of freshwater, acidified water, salt water, seawater, brine (e.g., a saturated salt solution), or an aqueous salt solution (e.g., a non-saturated salt solution), purified wastewater, deionized water, and any combination thereof.

Element 2: wherein the cement precursor is selected from the group consisting of Portland cement, fly ash, cement slag, pozzolan, volcanic ash, silica fume, quartz, and any combination thereof.

Element 3: wherein the cement precursor comprises one or more of silicon dioxide, calcium oxide, calcium hydroxide, iron oxide, aluminum oxide, titanium dioxide, magnesium oxide, strontium oxide, potassium oxide, sulfur trioxide, barium oxide, manganese oxide, manganese tetroxide, belite, alite, tricalcium aluminate, tetracalcium aluminoferrite, brownmilleriate, gypsum, limestone, hexavalent chromium, trivalent chromium, calcium aluminate, silica sand, silica flour, hematite, and any combination thereof.

Element 4: wherein the cement precursor is present in the fluid UF composition in an amount in the range of about 50% by weight to about 75% by weight.

Element 5: wherein the viscosifier is selected from the group consisting of guar gum, hydroxyalkyl gum, carboxyalkyl guar gum, xanthan gum, hydroxyalkyl xanthan gum, carboxyalkyl xanthan gum, carboxyalkyl hydroxyalkyl xanthan gum, cellulose, hydroxyalkyl cellulose, carboxyalkyl cellulose, carboxyalkyl hydroxyalkyl cellulose, and any combination thereof.

Element 6: wherein the viscosifier is present in the fluid UF composition in an amount in the range of about 0.05% by weight to about 1% by weight.

Element 7: wherein the delaying agent is selected from the group consisting of lignosulfonate, sodium borate, zinc borate, boric acid, sodium tartrate, sodium citrate, sodium gluconate, sodium itaconate, tartaric acid, citric acid, gluconic acid, itaconic acid, and any combination thereof.

Element 8: wherein the delaying agent is present in the fluid UF composition in an amount in the range of about 0.05% by weight to about 3% by weight.

Element 9: wherein the fluid loss control agent is selected from the group consisting of starch, hydroxyalkyl starch, carboxyalkyl starch, hydroxyethylcellulose, hydrophobically modified hydroxyethylcellulose, carboxymethylhydroxyethylcellulose, guar, modified guar, polyvinyl alcohol, polyethyleneimine, bentonite clay, montmorillonite clay, anhydrous sodium silicate, grafted polymers prepared by the polymerization of monomers or salts of monomers of N,N-dimethylacrylamide, 2-acrylamido-2-methylpropanesulfonic acid and acrylonitrile having a lignin or lignite backbone, copolymers or salts of copolymers of N,N-dimethylacrylamide and 2-acrylamido-2-methylpropanesulfonic acid, and any combination thereof.

Element 10: wherein the fluid loss control agent is present in the fluid UF composition in an amount in the range of about 0.05% by weight to about 3% by weight.

Element 11: wherein the activator is selected from the group consisting of sodium hydroxide, sodium silicate, potassium silicate, potassium hydroxide, sodium carbonate, sodium sulfate, lime, slaked lime, the like, and any combination thereof.

Element 12: wherein the activator is present in the fluid UF composition in an amount in the range of about 1% by weight to about 8% by weight.

Element 13: wherein the fluid UF composition has a plastic viscosity at 120° F. in the range of about 5 centipoise to about 100 centipoise.

Element 14: wherein the fluid UF composition has a yield point at 120° F. in the range of about 15 lbf/100 ft² to about 75 lbf/100 ft².

Element 15: wherein the fluid UF composition has a low shear yield point at 120° F. in the range of about 4 lbf/100 ft² to about 16 lbf/100 ft².

Element 16: wherein the formation temperature conditions are in the range of about 120° F. to about 200° F.

Element 17: wherein solidifying the fluid UF composition into a solid UF composition occurs over a solidification time period of about 20 days to about 70 days.

Element 18: wherein the solid UF composition has a compressive strength in the range of about 100 pounds per square inch to about 15,000 pounds per square inch.

By way of non-limiting example, exemplary combinations applicable to A, B and C include any one, more, or all of Elements 1-18 in any combination.

To facilitate a better understanding of the aspects of the present disclosure, the following examples of preferred or representative aspects are given. In no way should the following examples be read to limit, or to define, the scope of the disclosure.

### EXAMPLES

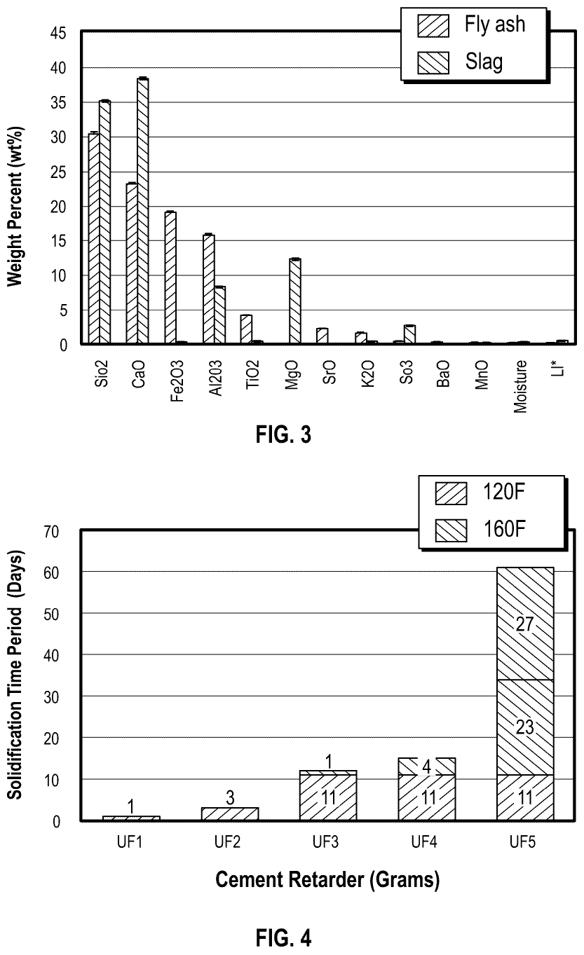

EXAMPLE 1: In this Example, the composition of a fly ash cement precursor and a blast furnace slag cement precursor for use in a UF composition were evaluated using x-ray fluorescence spectroscopy (XRF). As shown in FIG. 3, the various components of the two cement precursors overlap and include silicon dioxide (SiO₂), calcium oxide (CaO), iron oxide (Fe₂O₃), aluminum oxide (Al₂O₃), titanium dioxide (TiO₂), magnesium oxide (MgO), strontium oxide (SrO), potassium oxide (K₂O), sulfur trioxide (SO₃), barium oxide (BaO), manganese oxide (MnO), and trace amounts of moisture and organic matter loss upon ignition (LI). The primary components of both the fly ash cement precursor and the blast furnace slag cement precursor are SiO₂ (about 30 wt % to about 35 wt %), CaO (about 22 wt % to about 37 wt %), and Al₂O₃ (about 7 wt % to about 13 wt %).

EXAMPLE 2: In this Example, the solidification time period (e.g., setting time to form the solid UF compositions of the present disclosure) was evaluated using various delaying agent compositions. Six (6) samples of UF compositions in grams (g) were prepared as shown in Table 1, comprising an aqueous-based carrier fluid of deionized (DI) water; a cement precursor of SLAG120 (a finely ground, granulated blast furnace slag (GGBFS) available from Holcim, Switzerland); a pH adjuster of soda ash (available, for example, from M-I Swaco, Texas); a delaying agent of lignosulfonate (available, for example, from Borregaard, Norway); a viscosifier of xanthan gum (available, for example, from CP Kelco, Georgia); and a fluid loss control agent of modified non-ionic starch (in this case, CLEANTROL™ HD, available from Newpark, Texas). Notably, the compositions UF0-UF5 do not include an activator.

TABLE 1

| | | Cement | | | | | | Fluid Loss |
|---|---|---|---|---|---|---|---|---|
| | Carrier | Precursor | | Delaying | | | | Control |
| Sample | Fluid | (SLAG120) | Soda Ash | Agent | | Viscosifier | | Agent |
| UF0 | 140 g | 200 g | 0 g | 0.5 | g | 0 | g | 0 g |
| UF1 | 140 g | 200 g | 1 g | 0.5 | g | 0.6 | g | 3 g |
| UF2 | 140 g | 200 g | 1 g | 1 | g | 0.6 | g | 3 g |
| UF3 | 140 g | 200 g | 1 g | 2 | g | 0.6 | g | 3 g |
| UF4 | 140 g | 200 g | 1 g | 3 | g | 0.6 | g | 3 g |
| UF5 | 140 g | 200 g | 1 g | 4 | g | 0.6 | g | 3 g |

Each of UF0-UF5 were placed in a capped cell at 120° F. for at most 11 days, followed by heat rolling at 160° F. for a sufficient duration (if any) until the fluid UF composition converted into a solid UF composition. The results are shown in FIG. 4.

As shown in FIG. 4, the UF0 composition included no delaying agent, the UF1 comprising 0.5 g of delaying agent and UF2 comprising 1 g of delaying agent, solidified at 120° F. over a solidification time period of 1-3 days. UF3-5, each having a delaying agent concentration equal to or greater than 2 g, failed to solidify at 120° F. after 11 days elapsed. Accordingly, the temperature was increased to 160° F., where UF3 (2 g) solidified within 1 additional day (11 days at 120° F. and 1 day at 160° F.) and UF4 (3 g) solidified within 4 additional days (11 days at 120° F. and 4 days at 160° F.). UF5, having the most delaying agent (4 g), exhibited time ranges within 23 additional days to 50 additional days (11 days at 120° F. and 23-50 days at 160° F.).

The results of this Example demonstrate that the concentration of the delaying agent used in the UF compositions of the present disclosure is critical to the solidification time period for converting a fluid UF composition into a solid UF composition. Moreover, a relatively small amount of delaying agent can be used to ensure that the fluid UF composition remains in a fluid state for at least 23 days at 160° F. for the duration of a drilling operation (until the drilling operation is complete).

EXAMPLE 3: In this Example, the compressive strength of a UF composition of the present disclosure was evaluated, in which the UF composition additionally included an activator. One (1) sample of a UF composition in grams (g) was prepared as shown in Table 2, comprising an aqueous-based carrier fluid of DI water; a cement precursor of SLAG120; a pH adjuster of soda ash; a delaying agent of lignosulfonate; a viscosifier of xanthan gum; a fluid loss control agent (FLCA) of modified non-ionic starch; and an activator of sodium hydroxide (50 wt % NaOH).

TABLE 2

| | Carrier | Cement | | Delaying | | | |
|---|---|---|---|---|---|---|---|
| Sample | Fluid | Precursor | Soda Ash | Agent | Viscosifier | FLCA | Activator |
| UF6 | 140 g | 200 g | 1 g | 4 g | 0.4 g | 3 g | 20 g |

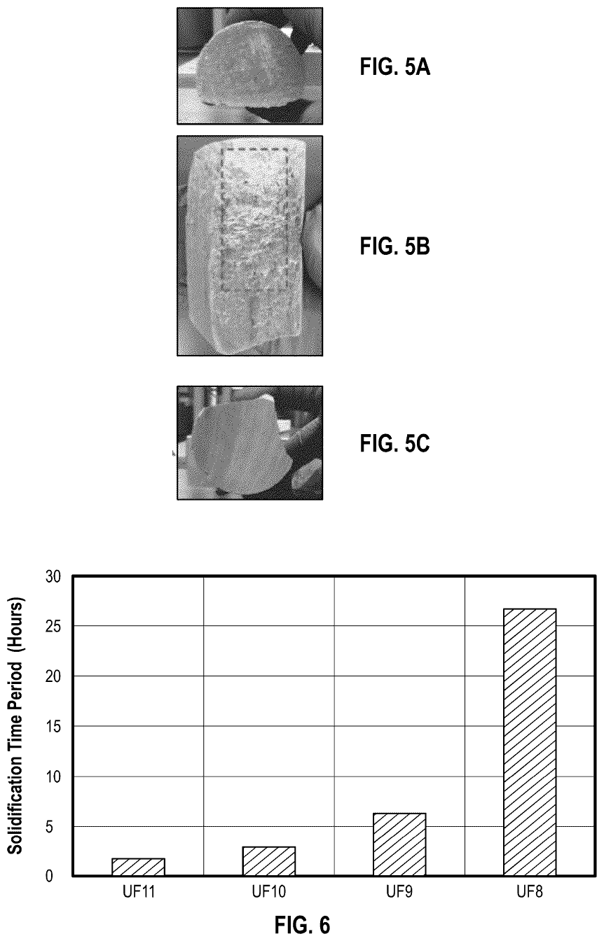

UF6 was heated at in a capped cell at 160° F. for 3 days to form a solid UF composition. The solid UF6 sample was removed from the capped cell and compression tested according to the standard method described hereinabove. The solid UF6 sample exhibited a compressive strength of 1,465 psi after 3 days at 160° F. FIGS. 5A-5C are photographs of the solid UF6 sample after compression testing. FIG. 5A shows a top cross-section of the solid UF6 sample; FIG. 5B shows a side, cracked view of the solid UF6 sample; and FIG. 5C shows a bottom cross-section of the solid UF6 sample. Accordingly, the solid UF compositions of the present disclosure exhibit compressive strength adequate for use as a portion of a cement sheath.

EXAMPLE 4: In this Example, the solidification time period of the UF compositions of the present disclosure was evaluated, in which the UF compositions additionally included an activator in varying concentrations. Five (5) samples of UF compositions in grams (g) were prepared as shown in Table 3, comprising an aqueous-based carrier fluid of DI water; a cement precursor of SLAG120; a pH adjuster of soda ash; a delaying agent of lignosulfonate; a viscosifier of xanthan gum; a fluid loss control agent of modified non-ionic starch; and an activator of sodium hydroxide (50 wt % NaOH).

TABLE 3

| | Carrier | Cement | Soda | Delaying | | | | |
|---|---|---|---|---|---|---|---|---|
| Sample | Fluid | Precursor | Ash | Agent | Viscosifier | FLCA | Activator | |
| UF7 | 140 g | 200 g | 1 g | 4 g | 0.4 g | 3 g | 2.5 | g |
| UF8 | 140 g | 200 g | 1 g | 4 g | 0.4 g | 3 g | 5 | g |
| UF9 | 140 g | 200 g | 1 g | 4 g | 0.4 g | 3 g | 10 | g |
| UF10 | 140 g | 200 g | 1 g | 4 g | 0.4 g | 3 g | 15 | g |
| UF11 | 140 g | 200 g | 1 g | 4 g | 0.4 g | 3 g | 20 | g |

Thickening time was evaluated at 160° F. until 70 Be was reached. The results are shown in FIG. 6, in which thickening time ranged between about 2 hours and about 28 hours with the inclusion of an activator under formation temperature conditions. Sample UF7, not shown on FIG. 6, had not reached 70 Bc before 50 hours had passed.

EXAMPLE 5: In this Example, fluid loss of the UF compositions of the present disclosure was evaluated using various fluid loss control agents. Thirteen (13) samples of UF compositions in grams (g) were prepared as shown in Table 4, comprising an aqueous-based carrier fluid of DI water; a cement precursor of SLAG120; a pH adjuster of soda ash; a delaying agent of lignosulfonate; a viscosifier of xanthan gum; and a fluid loss control agent of modified non-ionic starch (MS), modified natural cellulose (MNC), carboxymethyl cellulose (CMC), or a synthetic polymer (SP).

TABLE 4

| | UF12 | | UF13 | | UF14 | | UF15 | | UF16 | | UF17 | | UF18 | |
|---|---|---|---|---|---|---|---|---|---|---|---|---|---|---|
| Carrier Fluid | 140 | g | 140 | g | 140 | g | 140 | g | 140 | g | 140 | g | 140 | g |
| Cement | 200 | g | 200 | g | 200 | g | 200 | g | 200 | g | 200 | g | 200 | g |
| Precursor | | | | | | | | | | | | | | |
| (SLAG120) | | | | | | | | | | | | | | |
| Soda Ash | 1 | g | 1 | g | 1 | g | 1 | g | 1 | g | 1 | g | 1 | g |
| Delaying Agent | 4 | g | 4 | g | 4 | g | 4 | g | 4 | g | 4 | g | 4 | g |
| Viscosifier | 0.4 | g | 0.4 | g | 0.4 | g | 0.4 | g | 0.4 | g | 0.4 | g | 0.4 | g |

| | | | | | | | | |
|---|---|---|---|---|---|---|---|---|
| FLCA | 3 | g | N/A | N/A | N/A | N/A | N/A | N/A |
| (MS) | | | | | | | | |

| | | | | | | | | |
|---|---|---|---|---|---|---|---|---|
| FLCA | N/A | 3 | g | N/A | N/A | N/A | N/A | N/A |
| (MNC) | | | | | | | | |

| | | | | | | | | |
|---|---|---|---|---|---|---|---|---|
| FLCA | N/A | N/A | 3 | g | N/A | N/A | N/A | N/A |
| (CMC) | | | | | | | | |

| | | | | | | | | | | | |
|---|---|---|---|---|---|---|---|---|---|---|---|
| FLCA | N/A | N/A | N/A | 3 | g | 3 | g | 3 | g | 3 | g |
| (SP) | | | | | | | | | | | |

| | UF19 | | UF20 | | UF21 | | UF22 | | UF23 | | UF24 | |
|---|---|---|---|---|---|---|---|---|---|---|---|---|
| Carrier | 140 | g | 140 | g | 140 | g | 140 | g | 140 | g | 140 | g |
| Fluid | | | | | | | | | | | | |
| Cement | 200 | g | 200 | g | 200 | g | 200 | g | 200 | g | 200 | g |
| Precursor | | | | | | | | | | | | |
| (SLAG120) | | | | | | | | | | | | |
| Soda Ash | 1 | g | 1 | g | 1 | g | 1 | g | 1 | g | 1 | g |
| Delaying | 4 | g | 4 | g | 4 | g | 4 | g | 4 | g | 4 | g |
| Agent | | | | | | | | | | | | |
| Viscosifier | 0.4 | g | 0.4 | g | 0.4 | g | 0.4 | g | 0.4 | g | 0.4 | g |
| FLCA | N/A | | N/A | | N/A | | N/A | | N/A | | N/A | |
| (MS) | | | | | | | | | | | | |
| FLCA | N/A | | N/A | | N/A | | N/A | | N/A | | N/A | |
| (MNC) | | | | | | | | | | | | |
| FLCA | N/A | | N/A | | N/A | | N/A | | N/A | | N/A | |
| (CMC) | | | | | | | | | | | | |
| FLCA | 3 | g | 3 | g | 3 | g | 3 | g | 3 | g | 3 | g |
| (SP) | | | | | | | | | | | | |

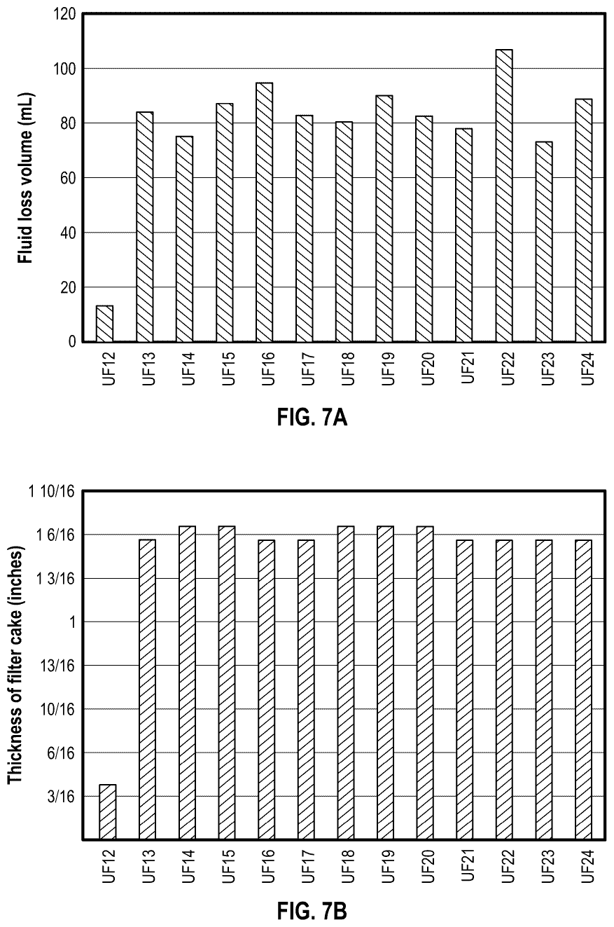

Each of UF12-UF24 were heat rolled for 16 hours at 160° F. and 500 psi differential pressure as described hereinabove. The volume of fluid loss is provided in FIG. 7A, and the thickness of the formed filter cake is provided in FIG. 7B. As shown the amount of fluid loss (FIG. 7A) and thickness of the filter cake (FIG. 7B) for the modified non-ionic starch fluid loss control agent is considerably reduced, showing about 13.4 mL per 30 minutes (mL/30 min). In contrast, other modified natural and synthetic polymers (UF13-UF24) display greater fluid loss of about 70 mL/30 min to about 110 mL/30 min under the same conditions.

EXAMPLE 6: In this Example, the fluid loss and rheological properties of the UF compositions of the present disclosure were evaluated using various fluid loss control agent concentrations. Two (2) samples of UF compositions in grams (g) were prepared as shown in Table 5, comprising an aqueous-based carrier fluid of 10 wt % NaCl in DI water; a cement precursor of SLAG120; a cement precursor of soda ash; a delaying agent of lignosulfonate; a viscosifier of xanthan gum; and a fluid loss control agent of modified non-ionic starch.

TABLE 5

| | | | | | | Fluid loss |
|---|---|---|---|---|---|---|
| | Carrier | Cement | | Delaying | | Control |
| Sample | Fluid | Precursor | Soda Ash | Agent | Viscosifier | Agent |
| UF25 | 154 g | 200 g | 1 g | 4 g | 0.4 g | 3 g |
| UF26 | 154 g | 200 g | 1 g | 4 g | 0.4 g | 5 g |

The API fluid loss volumes at 160° F. were tested as described hereinabove and the results are shown in Table 6.

TABLE 6

| | Fluid Loss Volume | Filter Cake Thickness |
|---|---|---|
| Sample | (mL) | (inches) |
| UF25 | 7.6 | 4/32 |
| UF26 | 4.8 | 3/32 |

The results indicate an ultra-low fluid loss volume and filter cake thickness for UF25 and UF26, which is favorable for using as a drilling fluid system.

The rheological properties at 120° F. were tested as described hereinabove and the results are shown in Table 7.

TABLE 7

| | UF25 | UF26 |
|---|---|---|
| Viscometer Shear Rate | Viscometer | Viscometer |
| (RPM) | Readings | Readings |
| 600 | 130 | 145 |
| 300 | e | 94 |
| 200 | 62 | 72 |
| 100 | 40 | 47 |
| 6 | 7 | 8 |
| 3 | 5 | 6 |
| | Rheology | Rheology |
| Rheology Properties | Measurements | Measurements |
| 10-second gel strength | 6 | 6 |
| (lbf/100 ft²) | | |
| 10-minute gel strength | 11 | 10 |
| (lbf/100 ft²) | | |
| PV (cP) | 45 | 51 |
| YP (lbf/100 ft²) | 40 | 43 |
| LSYP (lbf/100 ft²) | 3 | 4 |

The results indicate a favorable LSYP for the UF compositions of the present disclosure, having viscometer readings of 5-7 for UF25 and viscometer readings of 6-8 for UF26 at 3-6 RPM shear rate. The PV and YP values are additionally favorable for use as a drilling fluid.

Accordingly, the present disclosure provides compositions, methods, and systems for effective drilling and cementing (including fluid loss control) operations with a universal fluid composition comprising at least an aqueous-based carrier fluid, a cement precursor, and a delaying agent.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,” “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

It should be noted that when “about” is provided herein at the beginning of a numerical list, the term modifies each number of the numerical list. In some numerical listings of ranges, some lower limits listed may be greater than some upper limits listed. One skilled in the art will recognize that the selected subset will require the selection of an upper limit in excess of the selected lower limit. Unless otherwise indicated, all numbers expressing quantities of ingredients, properties such as concentration, temperatures, and so forth used in the present specification and associated claims are to be understood as being modified in all instances by the term “about.” As used herein, the term “about” encompasses+/−5% of a numerical value. Accordingly, unless indicated to the contrary, the numerical parameters set forth in the following specification and attached claims are approximations that may vary depending upon the desired properties sought to be obtained by the exemplary embodiments described herein. At the very least, and not as an attempt to limit the application of the doctrine of equivalents to the scope of the claim, each numerical parameter should at least be construed in light of the number of reported significant digits and by applying ordinary rounding techniques.

Terms of orientation are used herein merely for purposes of convention and referencing and are not to be construed as limiting. However, it is recognized these terms could be used with reference to an operator or user.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention is not limited to the particular embodiments disclosed, or to the best mode contemplated for carrying out this invention, but that the invention will include all embodiments falling within the scope of the appended claims. Moreover, references in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

1. A method comprising:
providing a flowable universal fluid (UF) composition that is settable from a fluid state to a solid state,
wherein the flowable UF composition is pre-mixed in the fluid state prior to introduction to a subterranean formation, the flowable UF composition in the fluid state comprising:
an aqueous-based carrier fluid;
a cement precursor; and
a delaying agent;
drilling a wellbore in the subterranean formation using the flowable UF composition in the fluid state as a drilling fluid,
wherein a portion of the flowable UF composition in the fluid state remains in the wellbore within one or more fluid loss zones upon completing the drilling;
after completing the drilling, introducing an activator to the portion of the flowable UF composition in the fluid state that remains in the wellbore, and
heating the portion of the flowable UF composition in the fluid state under formation temperature conditions, thereby solidifying the flowable UF composition in the fluid state into a solid UF composition in the solid state;
wherein the solid UF composition forms within the one or more fluid loss zones.

2. The method of claim 1, wherein the activator is selected from the group consisting of sodium hydroxide, sodium silicate, potassium silicate, potassium hydroxide, sodium carbonate, sodium sulfate, lime, slaked lime, and any combination thereof.

3. The method of claim 1, wherein the cement precursor is selected from the group consisting of Portland cement, fly ash, cement slag, pozzolan, volcanic ash, silica fume, quartz, and any combination thereof.

4. The method of claim 1, wherein the cement precursor comprises one or more of silicon dioxide, calcium oxide, calcium hydroxide, iron oxide, aluminum oxide, titanium dioxide, magnesium oxide, strontium oxide, potassium oxide, sulfur trioxide, barium oxide, manganese oxide, manganese tetroxide, belite, alite, tricalcium aluminate, tetracalcium aluminoferrite, brownmillerite, gypsum, limestone, hexavalent chromium, trivalent chromium, calcium aluminate, silica sand, silica flour, hematite, or any combination thereof.

5. The method of claim 1, wherein the cement precursor is present in the flowable UF composition in the fluid state in an amount of about 50% by weight to about 75% by weight.

6. The method of claim 1, wherein the delaying agent is selected from the group consisting of lignosulfonate, sodium borate, zinc borate, boric acid, sodium tartrate, sodium citrate, sodium gluconate, sodium itaconate, tartaric acid, citric acid, gluconic acid, itaconic acid, and any combination thereof.

7. The method of claim 1, wherein the delaying agent is present in the flowable UF composition in the fluid state in an amount of about 0.05% by weight to about 4% by weight.

8. The method of claim 1, wherein the flowable UF composition in the fluid state has a plastic viscosity at 120° F. of about 25 centipoise to about 100 centipoise.

9. The method of claim 1, wherein the flowable UF composition in the fluid state has a yield point at 120° F. of about 15 lbf/100 ft² to about 75 lbf/100 ft².

10. The method of claim 1, wherein the flowable UF composition in the fluid state has a low shear yield point at 120° F. of about 4 lbf/100 ft² to about 16 lbf/100 ft².

11. The method of claim 1, wherein the formation temperature conditions are about 120° F. to about 200° F.

12. The method of claim 1, wherein solidifying the flowable UF composition in the fluid state into the solid UF composition occurs over a solidification time period of about 20 days to about 70 days.

13. The method of claim 1, wherein the solid UF composition has a compressive strength of about 100 pounds per square inch to about 15,000 pounds per square inch.

14. A system comprising:
a drill string extendable into a wellbore from a drilling platform and conveying a flowable universal fluid (UF) composition into a subterranean formation, the flowable UF composition being pre-mixed prior to introduction into the subterranean formation and comprising:
an aqueous-based carrier fluid;
a cement precursor; and
a delaying agent;
wherein the flowable UF composition has a plastic viscosity at 120° F. of about 25 centipoise to about 100 centipoise;
wherein the flowable UF composition solidifies under formation temperature conditions, thereby forming a solid UF composition; and
wherein the drill string further introduces an activator to the subterranean formation subsequent to the flowable UF composition.

15. A composition comprising:
a pre-mixed flowable universal fluid (UF) composition, wherein the flowable UF composition comprises:
an aqueous-based carrier fluid;
a cement precursor;
a delaying agent; and
an activator;
wherein the flowable UF composition has a plastic viscosity at 120° F. of about 25 centipoise to about 100 centipoise; and
wherein the flowable UF composition solidifies under formation temperature conditions, thereby forming a solid UF composition.

16. The method of claim 1, wherein the cement precursor comprises titanium dioxide, strontium oxide, barium oxide, manganese oxide, or any combination thereof.

17. The method of claim 1, wherein the delaying agent comprises sodium tartrate, sodium gluconate, tartaric acid, gluconic acid, or any combination thereof.

18. The method of claim 1, wherein the delaying agent is present in the flowable UF composition in the fluid state in an amount of about 0.75% by weight to about 1.5% by weight.
